(19) United States
(12) Patent Application Publication
(10) Pub. No.: US 2026/0225418 A1
(43) Pub. Date: Aug. 6, 2026

(54) Vehicle Having Zero Tracking Front Arm Assemblies

(71) Applicant: Stephen Kariniemi, Phoenix, AZ (US)

(72) Inventor: Stephen Kariniemi, Phoenix, AZ (US)

(21) Appl. No.: 19/424,001

(22) Filed: Dec. 17, 2025

Related U.S. Application Data
(60) Provisional application No. 63/752,792, filed on Feb. 2, 2025.

(51) Int. Cl. B60G 3/18; B60G 7/00; B60G 7/02; B60G 13/00

(52) U.S. Cl. CPC B60G 3/185; B60G 7/008; B60G 7/02; B60G 13/005; B60G 2200/13; B60G 2204/129; B60G 2204/143; B60G 2204/148

(57) ABSTRACT

An All-Terrain Vehicle with a front arm designed to minimize lateral wheel tracking. The front arm may comprise an assembly comprising an upper front arm and a lower front arm, in an embodiment. The front arm may attach along a hinge line that is perpendicular to a longitudinal centerline of the vehicle. Tire tracking can be a safety hazard for ATV's and off road vehicles. In conventional systems, as a wheel droops, the wheel can have an arcuate path inward or laterally towards the centerline of the vehicle. If this tire tracking, or inward distance, is too large, a safety hazard situation may exist. This disclosure describes a way to overcome or minimize this tire tracking.

### CROSS-REFERENCE TO RELATED APPLICATIONS

This application is related to and claims priority to the U.S. Provisional Application No. 63/752,792, filed on Feb. 2, 2025. The entire contents of the above applications are incorporated by reference herein.

### TECHNICAL FIELD

The invention relates to front arm assemblies for wheeled vehicles, especially all-terrain vehicles (ATVs), recreational off-highway vehicles (ROVs), utility task vehicles (UTVs), side-by-side vehicles, and similar off-road vehicles.

### BACKGROUND

Conventional front arm assemblies on such vehicles typically use front arms (hinge axis substantially parallel to the vehicle's longitudinal centerline), double-wishbone (A-arm) arrangements, or MacPherson struts. In virtually all of these designs, vertical wheel travel is accompanied by appreciable lateral translation of the wheel relative to the vehicle centerline (“tracking”) during up and down motion of the front arm. This lateral movement increases tire wear, raises rolling resistance, and, at large suspension travels, can create handling instability and safety concerns. The present invention eliminates or dramatically reduces such lateral tracking.

### SUMMARY OF THE INVENTION

The present invention relates to a zero tracking front arm assembly for wheeled vehicles, particularly all-terrain vehicles (ATVs), recreational off-highway vehicles (ROVs), utility task vehicles (UTVs), and similar vehicles, comprising front arms characterized by substantially zero or zero (“zero tracking front arm”) or dramatically reduced lateral tracking of the front wheels during vertical suspension travel compared to conventional designs.

In one embodiment, the front arm assembly (e.g., a first (e.g., upper) and second (e.g., lower) zero tracking front arms are hinged to the vehicle frame along a hinge axis, oriented substantially perpendicular to the vertical wheel travel path (e.g. substantially perpendicular to longitudinal length of vehicle, for example up to +/−2 degrees, 5 degrees, 10 degrees), and attached to the frame. This perpendicular hinge orientation results in near-zero lateral (inward or outward) translation of the wheel and spindle assembly as the suspension articulates through its full range of vertical travel, unlike traditional parallel-hinged arms (hinge axis that is oriented substantially parallel to wheel path, e.g., parallel to longitudinal length of vehicle), that produce significant tracking or conventional double-wishbone (A-arm) configurations that exhibit moderate tracking. In preferred embodiments, the lateral-to-vertical travel ratio is reduced to 0:1 (true zero tracking) or to extremely low ratios such as 1/30, 1/28, 1/24, 1/20 or less (e.g., ≤1 inch, or less than 2 inches, or less than 3 inches of lateral movement over 20-30 inches of vertical wheel travel), thereby minimizing tire tracking, improving tire wear, and enhancing vehicle stability and handling. The tracking that occurs on vehicles increases with the travel, to a point where it presents a significant safety issue.

The front arms may be constructed as tubular steel members (or other suitable materials) and may incorporate arcuate shapes when viewed from above, from the side, or both, to provide (a) clearance for steering arm angles, (b) clearance for shock absorbers and other components, clearance for the rearward portion of the wheel when turning, and/or (c) a U shaped configuration that “wraps-around” the cockpit gas/brake pedal area (ie; foot area on the driver and passenger side) and attaches to frame hinge points. The front arms hinge points can be positioned rearward of the foot area (or most forward foot area) tube. In one embodiment, the “U-shaped” configuration can increase or maximize front arm length without increasing wheel base length significantly. In one embodiment, for a desired front arm length, wheel base length can decrease. In one embodiment front arm length from hinge line to wheel axis is approximately 33 inches and wheel base length is approximately 117 inches, or approximately a 0.28 front arm length to wheelbase ratio. In some embodiments, the front arm length/wheel base ratio may be greater than 0.27, 0.28, 0.29, 0.3, 0.32, 0.33, 0.34, 0.35 or more. Front arm assembly length can contribute to the up and down travel distance of the front wheel. In one embodiment, a U-shaped (wrap around or non enclosed space design) design can enable a similar wheel base distance with longer front arm assembly length as compared to a non wrap around design. In one embodiment, this “U-shaped” configuration permits a shorter wheelbase while achieving similar or longer suspension travel, compared to a non wrap around design, and when configured to be attached to a frame as described herein, minimizing inward lateral motion (travel inwards towards center of vehicle.

In one embodiment, adjustability of camber is achieved via rod ends(heim joints), at the outboard (spindle assembly) connection, while caster adjustment is provided at the inboard (frame) hinge points. Wide spacing of the inboard frame hinge mounts enhances resistance to lateral loads encountered during turning and/or impacts, for example.

Steering is accomplished via a longitudinally oriented “double rack” steering assembly wherein the dual racks rod end pivot point (e.g., tubes) connected to the steering bracket pivot point on the spindle assemblies, pushes and pulls in unison, thereby converting longitudinal rack motion into wheel turn-in/turn-out, keeping the wheels parallel (substantially parallel to longitudinal center line of the vehicle). Alternative steering embodiments include conventional transverse single racks with flexible material in a rigid shaped steering arm portions, or a steer-by-wire system. The double rack steering assembly location is optimized to minimize or eliminate bump steer throughout the suspension travel range. Spindle assemblies may incorporate rod-end or uniball design, angled up to 45 degrees or more to maximize steering angle.

The zero tracking front arm assembly may also accommodate front-wheel-drive mechanisms while maintaining the zero tracking characteristics. Thus, the invention provides a simple, robust, adjustable, and compact zero tracking front arm assembly that dramatically reduces or eliminates wheel tracking during vertical travel, enables large steering angles and long suspension travel in a short-wheelbase vehicle (in one embodiment), and improves overall performance, durability, and tire life compared to prior-art parallel-arm, A-arm, or other front arm assemblies. This disclosure and figures show a vehicle comprising a frame; one frame first attachment zone; a first zero tracking front arm; wherein the first zero tracking front arm is attached to the first frame attachment zone; and wherein when the first zero tracking front arm is moved upward or downward, any multiple of points along the first zero tracking front arm keep a substantially equal distance from a longitudinal centerline along the frame. The vehicle may comprise a second attachment zone wherein the second attachment zone is outward from the first attachment zone and wherein the first zero tracking front arm is attached to the first attachment zone and the second attachment zone. In one embodiment the vehicle may further comprise a second zero tracking front arm wherein the second zero tracking front arm is attached at a third attachment zone and wherein the third attachment zone includes a hinged mechanism. The third attachment zone may be located below the first attachment zone. In one embodiment, the vehicle may further comprise a fourth attachment zone wherein the second zero tracking front arm is attached to the third attachment zone and the fourth attachment zone. In one embodiment, the first zero tracking front arm and second zero tracking front arm are attached to each other in a parallel configuration (e.g., when the first and second zero tracking front arms are level or perpendicular to frame attachment zones) and are attached to a spindle assembly creating a “zero tracking front arm assembly”. In one embodiment, the zero tracking front arm assembly is configured to move down or up (e.g., in a vertical direction) and to accommodate a wheel attached to the vehicle wheel assembly to turn up to 45 degrees inward. In one embodiment the zero tracking front arm assembly comprises a U shape configuration (one or both (if two exist on a drivers or passenger side) of the front arm(s) that make up the zero tracking front arm assembly may have a U shaped configuration, i.e, “wrap around design”). In one embodiment, a first zero tracking front arm comprises a first frame attachment zone (e.g., hinge mechanism capable) and a first spindle assembly attachment zone; wherein the first frame attachment zone is configured to be attached to a vehicle frame and the first spindle attachment zone is configured to be attached to a spindle assembly; and wherein the first zero tracking front arm comprises at least one reference point (in one embodiment multiple reference points along a longitudinal length of the front arm, for example 1 inch apart) along the first zero tracking front arm and wherein the first zero tracking front arm is configured such that when the first zero tracking front arm is attached to a vehicle frame (along the attachment zone(s)), the at least one reference point is substantially equal distance from a longitudinal centerline along the frame when the first zero tracking front arm is moved in a vertical direction. In one embodiment, the first zero tracking front arm further comprises a second zero tracking front arm and wherein the second zero tracking front arm comprises at least a first frame attachment zone and a spindle assembly attachment zone and the first and second zero tracking front arms are attached to each other by the spindle assembly creating a zero tracking front arm assembly. The zero tracking front arm assembly enables the first and second zero tracking front arms to be in a parallel configuration at mid level (vertically) suspension travel when attached to a vehicle.

### BRIEF DESCRIPTION OF FIGURES

FIG. 1—A side view of an ATV according to an embodiment with zero tracking front arm assemblies.

FIG. 2—A perspective view of an atv according to an embodiment with zero tracking front arm assemblies.

FIG. 3A—A top view of an atv according to an embodiment with zero tracking front arm assemblies with a U shape configuration for a wrap around embodiment.

FIG. 3B—A top view of an atv according to an embodiment with zero tracking front arm assemblies in a non U shaped configuration.

FIG. 4—A side view of an atv according to an embodiment with zero tracking front arm assemblies showing shock in an extended position.

FIG. 5A—A front view of an atv according to an embodiment with zero tracking front arm assemblies with shock in a compressed state and wheels straight.

FIG. 5B—A front view of an atv according to an embodiment with zero tracking front arm assemblies with shock in a ride height state and wheels straight.

FIG. 6A—A partial top view of an atv according to an embodiment with zero tracking front arm assemblies with wheels in a turned in configuration.

FIG. 6B—A partial top view of an atv according to an embodiment with zero tracking front arm assemblies with wheels turned out configuration.

FIG. 7—A partial side view of an atv according to an embodiment with zero tracking front arm assemblies and shock in a compressed state.

FIG. 8—A top view of a zero tracking front arm assembly with a dual rack steering assembly detail per an embodiment.

FIG. 9—A dual rack steering assembly per an embodiment.

FIG. 10—A partial top view of a lower zero tracking front arm assembly and a conventional single rack steering assembly with an arcuate shape per an embodiment.

FIG. 11—A top view of a dual rack steering assembly per an embodiment.

FIG. 12—A partial side view of a zero tracking front arm and steering assembly per an embodiment.

FIGS. 13A-13C—A side view of a zero tracking front arm and steering assembly in different configurations through travel.

FIG. 14—A top view of a lower zero tracking front arm tube(s).

FIG. 15—A top view of a lower zero tracking front arm plate.

FIG. 16—A top view of an upper zero tracking front arm tube(s).

FIG. 17—A top view of an upper zero tracking front arm plate.

FIGS. 18A, 18B, 18C show a detailed view of the spindle assembly and steering bracket.

### DETAILED DESCRIPTION

Reference will now be made to some embodiments illustrated in the drawings, and specific language will be used herein to describe the same. It will nevertheless be understood that no limitation of the scope of the invention is thereby intended. Alterations and further modifications of the inventive features illustrated herein, and additional applications of the principles of the inventions as illustrated herein, which would occur to one skilled in the relevant art and having possession of this disclosure, are to be considered within the scope of the invention.

A vehicle with zero tracking front arm assemblies in accordance with various embodiments are disclosed herein and examples are illustrated in the Figures. The zero tracking front arm assemblies may have a tubular (tubular is not to be read as only circular, for example, it could have a rectangular shape) construction and can be cut to length depending on a particular application. For example, the zero tracking front arm assembly may be constructed from a structural component or member, e.g., a tube made out of a tubular-shaped steel alloy. The zero tracking front arm assembly may be individual pieces, for example 2 individual pieces. In some embodiments, some of the individual pieces may be connected to each other by a welding. The structural component (e.g., tubular zero tracking front arm assembly) may have a tubular construction typically ranging from approximately 1 inch to 8 inches in diameter or whatever diameter is required for adequate strength or looks. The zero tracking front arm assembly can be shaped to accommodate a wheel to turn up to 45 degrees or more. The zero tracking front arm assembly may be attached at the frame, with a bushing or rod end, using tabs and a bolt and at the spindle assembly a rod end bolted or a uniball welded to a spindle assembly. The zero tracking front arm assembly may have an arcuate shape or bend or change in direction to help accommodate more wheel turning. The zero tracking front arm assembly may move less in a lateral direction than a longitudinal direction during an up and downward motion of the zero tracking front arm assembly. In some embodiments the zero tracking front arm assembly may attach to a frame at 90 degrees or perpendicular to the frame length (the vehicle travel direction) to have zero tire tracking. In some embodiments the zero tracking front arm assembly may attach to the frame at an angle that isn't perpendicular to the frame length allowing some wheel tracking (inward movement of wheel to centerline) in order to achieve other benefits, thereby the wheel assembly and tire may range from zero tire tracking up to 6″ of tire tracking in a lateral direction from centerline of vehicle while moving upward and downward depending on angle of effective hinge line attachment. Zero or little tire tracking of the front wheel is desirable for safety reasons, easier handling and less tire wear, for example. In one embodiment, a first proximal portion is configured to be hingedly attached to a vehicle frame at a first hinge point and a second proximal portion configured to be hingedly attached to the vehicle frame at a second hinge point, the first and second hinge points defining a hinge axis wherein the hinge axis is substantially perpendicular to a longitudinal centerline of the vehicle frame; and a distal portion configured to be attached to a spindle assembly at a spindle attachment point; and wherein the front arm is configured such that a first perpendicular distance, measured perpendicular to the hinge axis from the first hinge point to the spindle attachment point axis, is substantially equal to a second perpendicular distance, measured perpendicular to the hinge axis from the second hinge point to the spindle attachment point.

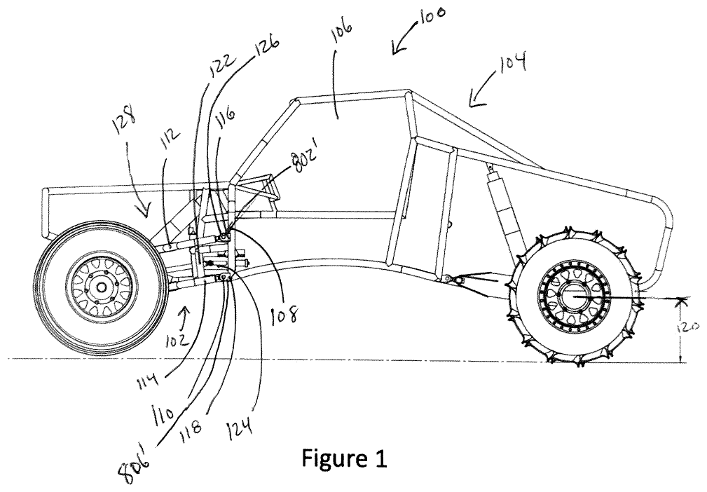

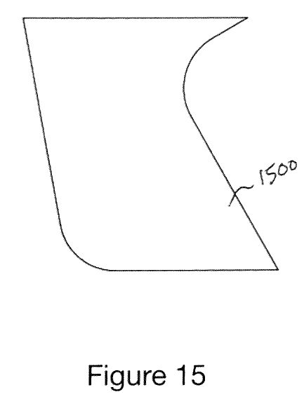

In an embodiment, as shown in FIG. 1, an ATV 100 with an embodiment of the invention with front arm assembly 102 at ride height. An ATV frame 104 may be constructed in any known way to accommodate the zero tracking front arm assembly. For example, an ATV frame 104 can be constructed similar to U.S. Pat. No. 9,493,191. A passenger compartment 106 may have an arcuate shape along a bottom periphery for extra clearance, for example. A front arm assembly 102 may be attached to the passenger compartment frame 108 with hinge attachment regions (e.g., line) 110, 126 that is perpendicular (or substantially perpendicular) to a longitudinal line 302 along the length of the ATV. The front arm assembly 102 may comprise a first (e.g., upper) front arm 112 and a second (e.g., lower) front arm 114. The first front arm 112 and second front arm 114 may be attached at multiple points along the passenger compartment frame 108 (e.g., to a portion of the ATV frame further away from a longitudinal centerline 302 and a portion attached closer to the centerline 302). For example, the first front arm 112 may be configured with hinge mechanisms 800, 802 that can hinge with mating hinge mechanisms 800′,802′ along a hinge attachment region 126. For example, first front arm 112 may attach at a first attachment zone 200 and a second attachment zone 202. The second (e.g., lower) front arm 114 may be configured with hinge mechanisms 804, 806 that can hinge with mating hinge mechanisms 804′, 806′ attached to the ATV passenger compartment frame 108, at a third attachment zone 202 and a fourth attachment zone 118 (the third attachment zone 202 and fourth attachment zone 118 may be located below the first attachment zone 200 and the second attachment zone 116). In one embodiment, the front arm assembly 102 forms a U-shaped configuration (e.g. between a first and second proximal end of a respective front arm may have a non enclosed open space) 828, wherein the front arm assembly can “wrap around” the foot area of the ATV 100, or a portion of the passenger compartment frame 108. In an embodiment, the front arm assembly is hinged behind (rearward) of the front tube 122 of foot box area 124. For example, the front arm assembly 102 can be hinged near the door jamb of the passenger compartment frame 108 (or a frame portion of the vehicle) and also hinged on another portion of the front arm near the center line of the atv, where the atv frame (e.g. foot box 124) is inset between the hinged portions. By having this type of configuration, the length between the front wheel and rear wheels can be decreased without losing front arm length. Front arm length 400 (e.g., 32.5 inches) contributes to the up and down travel distance 1300 (e. g, 27.86 inches in one embodiment), as shown in FIG. 13C, of the front wheel. In one embodiment, the front arms 112,114 (and respective passenger side front arms) can attach at the same longitudinal distance 300 along the ATV. In one embodiment, the front arms 112,114 can attach at different longitudinal distances 300, with design tradeoffs. In one embodiment, the front arms attach at a distance rearward of the most frontward portion of the foot compartment. FIG. 1 shows the front arms 112, 114 in a neutral (e.g., ride height) configuration. The ride height configuration can be set with the shock at a mid point along its travel from a minimum travel and maximum travel.

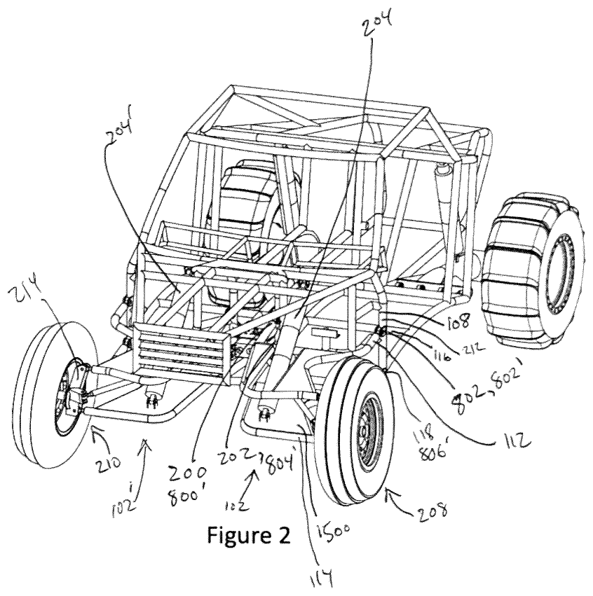

In one embodiment, as shown in FIG. 2, an ATV 100 comprises a driver side front arm assembly 102 and a passenger side front arm assembly 102'. A shock 204 can attach to the ATV frame 108 and to an upper or lower front arm assembly (112,114). In one embodiment the shock 204 attaches to a second front arm plate 1500. The second front arm 114 and first front arm 112 attach to a wheel assembly 208 (e.g., via a spindle assembly 210). As shown in FIG. 2, the first front arm 112 and second front arm 114 attach to the ATV frame 108 (e.g., passenger compartment frame) near an outer portion of the ATV and near an inner portion of the ATV, for example 25 inches apart or greater than 20 inches. As shown in FIG. 2, the first front arm 112 may be attached to a side pillar 212 of the ATV passenger compartment. The first (upper) and/or second (lower) front arms (112,114) can have a front arm arcuate shape 812 (e.g., outer edge of front arm has clearance for wheel assembly 208 when the rearward side of wheel is turned in). In one embodiment, the first (upper) front arm 112 comprises a first proximal end portion 808 configured with a hinge configuration 800 and a second proximal end portion 812 configured with a hinge configuration 802. In one embodiment, the second front arm 114 has a similar proximal end portion 808′ configured with a hinge configuration 804 and a second proximal end portion 812′ configured with a hinge configuration 806. The hinge configurations (800,802,804,806) align with a matching or respective hinge configuration (800′, 802′, 804′, 806′) attached to attachment zones (200, 116, 202, 118) on frame 108 and enable front arms (112,114) to move upward about hinge lines (126, 110). The first and third attachment zones (200,202) are located inward compared to second and fourth attachment zones (116,118). In one embodiment, the first front arm (112) and the second front arm (114) are attached to each other in a parallel (or substantially parallel) configuration at a point along shock 204 travel. The first and second front arms can be connected by a connecting member 214 (e.g., spindle assembly), thereby defining a front arm assembly 102, and the front arm assembly 102 is configured to move down or up while allowing a wheel to turn 45 degrees. In one embodiment, the front arm assembly 102 is attached to a drivers side and a second front assembly is 102′ is attached to a passenger side relative to the longitudinal centerline 302.

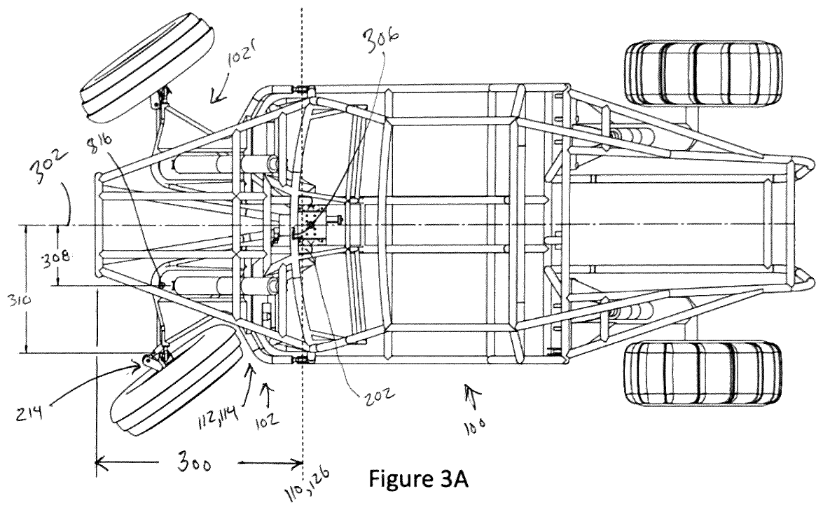

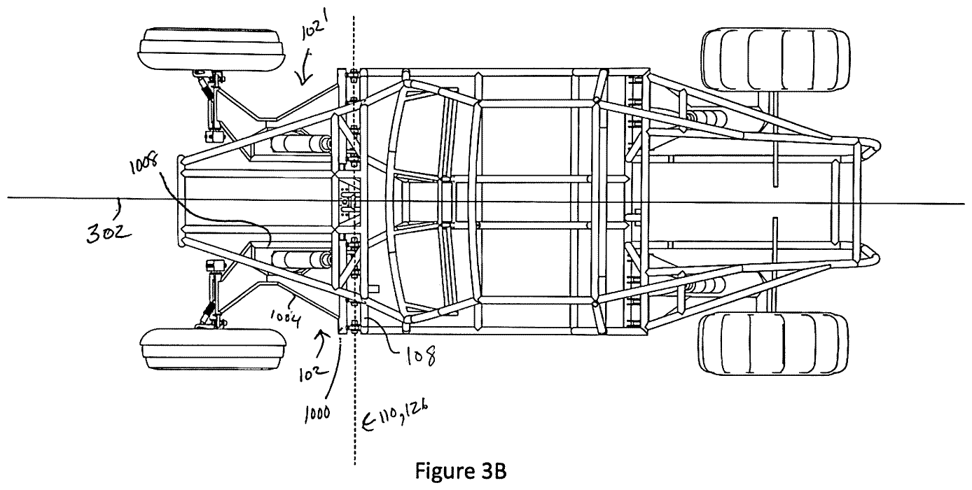

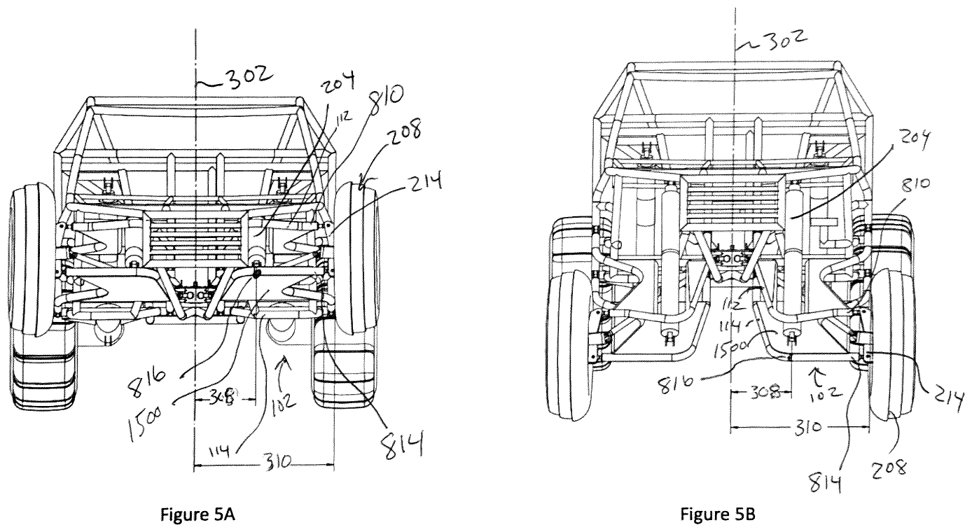

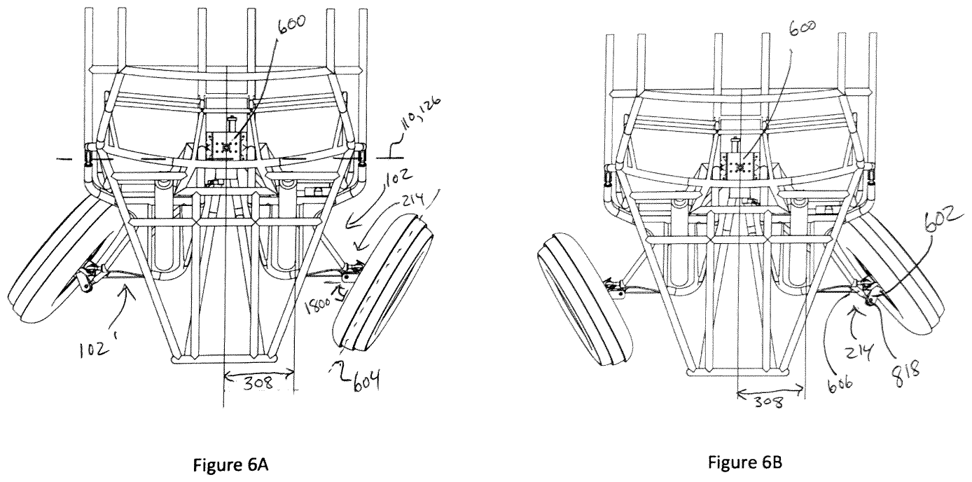

In one embodiment, as shown in FIG. 3A, an ATV 100 can comprise a front arm assembly 102, 102′ (e.g., a first and second or drivers side and passenger side). The front arm assembly 102 (e.g., first front arm 112 and second front arm 114 connected via a spindle assembly 214) is hinged to the ATV frame 108 along a hinge line (e.g., first or upper front arm hinge line 110, second or lower hinge line 126) of the front arm assembly 102. The hinge lines (110, 126) are substantially perpendicular (306) to a longitudinal center line 302 of the ATV (e.g., when viewing from a top view), thus allowing (e.g. multiple of points along respective front arms) the front arm assembly 102 to be a substantially same distance (e.g., less than 1 inch, less than 2 inches, less than 3 inches, less than 4 inches, less than 5 inches, less than 6 inches) respectively from the longitudinal center line 302 of the ATV when then front arm assembly 102 (and respective front arms 112,114 if not connected to each other) is moved in a vertical direction (e.g. 1 inch, 2 inch, 3 inch, 4 inch, 5 inch, 6 inch, 7 inch, 8 inch, 9 inch, 10 inch, 11 inch, 12 inch, 13 inch, 14 inch, 15 inches or more) along hinge lines (110, 126). In one embodiment the shock 204 is attached 13.75 inches from the longitudinal center line 302. In one embodiment, at least one point, (e.g., multiple points) on the front arm assembly 102 (or a respective individual front arm) will be substantially the same distance from the longitudinal centerline 302 of the ATV when the front arm is moved vertically at its distal end (for example, when front arm distal end is moved vertical 6 inches, lateral movement is less than 1 inch, 2 inches, 3 inches). For example, as shown in FIG. 3A, a front arm reference point 816, at ride height, located at outward dimension 308 (e.g., lateral perpendicular dimension) from centerline (e.g., 13.75 inches from longitudinal center line), maintains same distance (e.g., 13.75 inches (substantially)) when the front arm assembly is moved vertical between ride height (or a first position, e.g., neutral) about (e.g., along hinge lines 110, 126) towards a second configuration (e.g. substantially full extension of shock or full compression of the shock). This is also shown in FIGS. 5A and 5B. In one embodiment, as shown in FIG. 3A, a drivers side front assembly 102 and a passenger side front arm assembly 102′ are attached to the vehicle frame 108 at first, second, third, and fourth attachment zones respectively. A first front arm 112 is configured to attach to the shock 204 (e.g. via front arm plate 1500), having a first front arm first proximal end portion 808 and a first front arm first distal end portion 810 opposite the first front arm first proximal end portion 808. The first front arm first proximal end portion 808 is configured to be attached to the first frame attachment zone 200 (e.g., via hinge mechanisms 800, 800′). In one embodiment the first front arm first distal end portion 810 is moved vertically between a first configuration (e.g., a neutral travel configuration of the shock) and a second configuration (e.g., a maximum travel configuration of the shock), a reference point 816 along the first front arm 112 has substantially same perpendicular dimension 308 (e.g., lateral perpendicular dimension) from a longitudinal centerline 302 along the vehicle. In one embodiment the ATV comprises a second front arm 114 wherein the second front arm 114 comprises a second front arm first proximal end portion 808′ and the second front arm first proximal end portion 808′ is configured to be attached to the ATV frame (e.g., at a third frame attachment zone 202). In one embodiment, the ATV comprises a fourth frame attachment zone 118 and wherein the second front arm 114 further comprises a second front arm second proximal portion 812′ and wherein the second front arm second proximal portion 812′ is configured to be attached to the ATV frame 108 (e.g., at the fourth frame attachment zone 118), and configured to pivot or hinge when distal portion of the front arm is moved vertically. In one embodiment the frame attachment zones (200, 116, 202, 118) comprise a rod end hinge mechanism (similar to 800, 802, 804, 806). In one embodiment, the first front arm 112 and the second front arm 114 first distal end portions (810, 814) are attached to a spindle assembly 214 and wherein the first front arm 112 and the second front arm 114 are in a parallel configuration at a point (a configuration) throughout designed position (within suspension travel). In one embodiment, the first front arm 112 and the second front arm 114 are configured (e.g., an arcuate shape) to allow a wheel assembly 208 with a tire to turn inward, wherein the tire is at least 20 inches.

FIG. 3B shows, by way of example, an alternative embodiment of the front arm assemblies (102, 102′) have an enclosed space along hinge lines (110, 126). In one embodiment (as shown) the front arm assembly is not attached rearward of the foot area. The first front arm 112 and the second front arm 114 comprise a proximal portion 1000 that connects inner portion 1008 and outer portion 1004 along proximal portion 1006 of the front arms (112, 114). The proximal portion 1000 comprises a pivot mechanism (e.g., a hinge mechanism) along a hinge line (110, 126) that connects to frame 108.

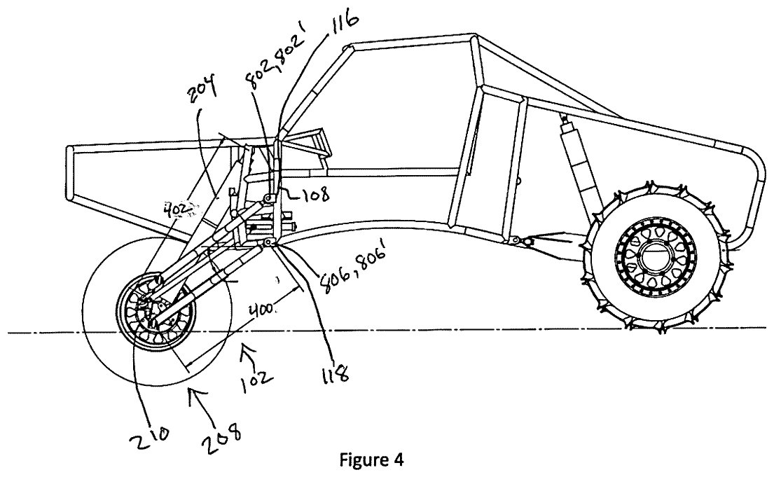

FIG. 4 shows, by way of example, a front arm assembly 102 with a shock 204 with a shock configuration in an extended dimension 402 of approximately 41.5 inches. In one configuration, the shock can extend 41.5 inches and the front arm assembly can rotate a dimension 404 of 35.5 degrees about hinge lines 110,126. In one configuration the front arm assembly 102 has a length 400 of approximately 32.5 inches. A second attachment zone 116 is fixed to the frame 108 and comprises a hinged mechanisms 802,802', and a fourth attachment zone 118 is attached to the frame 108 and comprises a pivot mechanism 806, 806′ (e.g., rod ends (e.g. heim joints), bushings, or other known mechanisms to provide a pivot motion at the frame). A first front arm assembly 102 is attached to the first attachment zone 200 and extends to a spindle assembly 210 attachment zone that supports a spindle assembly, wheel hub assembly 208 comprising a wheel/tire, so that when the vehicle shock is activated the wheel and tire will go in an up and down motion that has a substantially same lateral dimension 310 from a longitudinal centerline 302 ride height as it does when shock is compressed or extended (thereby referred to as “zero lateral tracking”).

FIG. 5A shows, by way of example, a front view of an ATV with the shocks in a compressed configuration. FIG. 5B shows, by way of example, a front view of an ATV with the shocks at ride height configuration. As shown illustrated in FIGS. 5A-5B, when the first front arm assembly 102 is moved upward or downward a reference point (e.g., 816) near the distal end portion or at wheel assembly 208, keeps a substantially equal distance 308 (e.g., lateral perpendicular dimension) from the longitudinal centerline 302.

A reference point 816 at approximately 13.5 inches as shown, is at same lateral perpendicular distance 308 when at ride height from center line of ATV when the front arm assembly 102 (e.g., comprising a first and second front arm) is moved vertical (e.g., towards a substantially full compressed shock configuration and/or to a substantially full extended shock configuration). In one embodiment the reference point(s) (816, 214) on a front arm has same lateral perpendicular distance dimensions (308, 310) from centerline when the front arm is moved at least 2 inches, 3 inches, 4 inches, 5 inches, 6 inches, 7 inches, 8 inches, 9 inches, 10 inches, 12 inches, 14 inches or more. For example, the front arm 112, 114 reference point can have a level or neutral ride height lateral perpendicular dimension from the centerline 302 of the vehicle that is substantially equal to a lateral perpendicular dimension from the centerline of the vehicle at the vertical distance moved (e.g., 2 inches, 3 inches, 4 inches, 5 inches, 6 inches, 7 inches, 8 inches, 9 inches, 10 inches, 12 inches, 14 inches or more). In one embodiment, the ride height can be considered a zero or neutral configuration. In one embodiment, as shown in FIGS. 5A and 5B, an ATV has a frame 108, a shock 204 and a first frame attachment zone located on the frame. A first front arm 112 is configured to attach to the shock (e.g. to the front arm tubes or a plate 1500), having a first front arm first proximal end portion and a first front arm first distal end portion 810 opposite the first front arm first proximal end portion. The first front arm first proximal end portion 808 is attached to the first frame attachment zone 200. The first front arm first distal end portion 810 is moved vertically between a neutral travel configuration (e.g. FIG. 5B) of the shock and towards a maximum travel configuration of the shock (e.g., FIG. 5A), a reference point (816, 214) along the front arm has the substantially same lateral perpendicular dimension (308, 310) respectively, from a longitudinal centerline 302 along the vehicle. In one embodiment the ATV comprises a second front arm 114 wherein the second front arm 114 comprises a second front arm first proximal end portion 808′ and the second front arm first proximal end portion 808′ is attached to a third frame attachment zone 202. In one embodiment, the ATV comprises a fourth frame attachment zone 118 and wherein the second front arm 114 further comprises a second front arm second proximal portion 812′ and wherein the second front arm second proximal portion 812′ is attached to the fourth frame attachment zone 118.

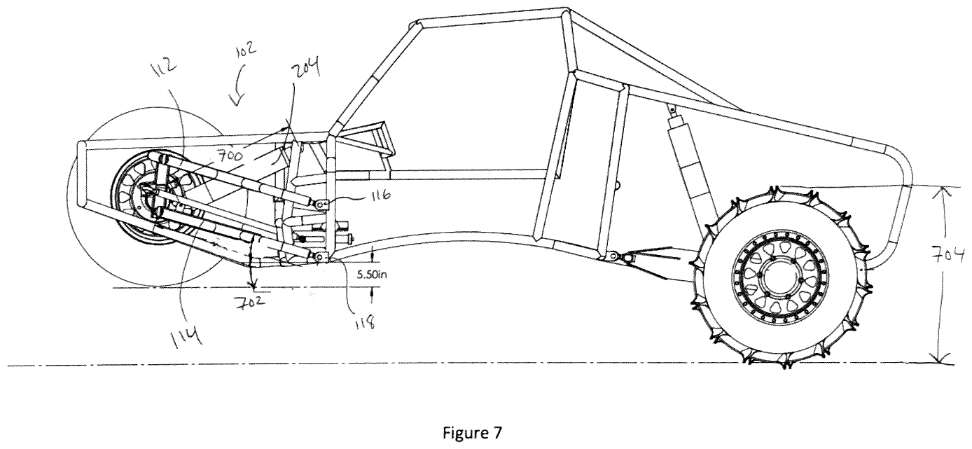

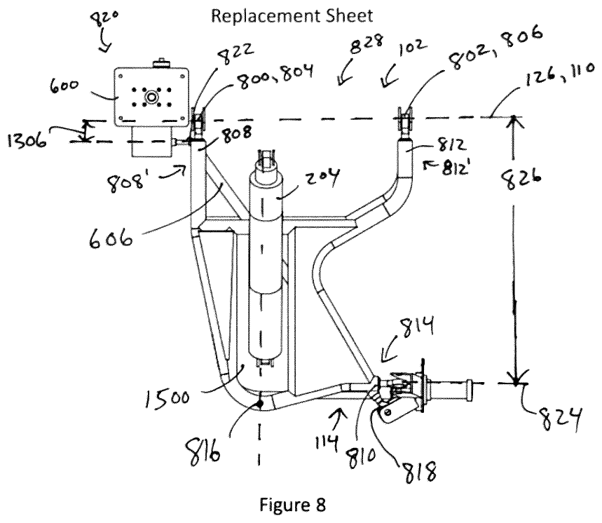

FIG. 6A and FIG. 6B shows, by way of example, a U-shaped configuration (wrap around) front arm assemblies (102, 102′) with wheels turned approximately 45 degrees. In one embodiment, a dual rack steering box 600 is located behind (rearward) the spindle assemblies 214, for example, at least 5 inches, 10 inches, 15 inches, 20 inches, 30 inches, 33 inches or more. In one embodiment, the steering rod proximal end 822 (e.g., in the dual rack steering box slot 1304) is located forward (e.g., approx. 3.5 inches) in respect to the hinge line 110, 126, thereby wherein the distal (forward) steering rod end 818 (e.g., opposite end of the rearward steering rod end swivel point) is substantially equal distant (e.g., 3.5 inches) forward of spindle assembly swivel point (810, 814) wherein the steering rod distal end attaches to the spindle assembly 214, thus enabling the steering rod end 818 (and therefore the dual rack steering assembly) to swing in an arc similar to the front arm assembly 102, to prevent or reduce bump steer or binding. In one embodiment, a spindle assembly bracket 602 is located at an angle 1800 of approximately 45 degrees inward from the longitudinal wheel axis line 604 to enable dual rack steering assembly to achieve the above said configuration. A straight (or substantially straight) steering tube 606 is part of the dual rack steering assembly to connect to the spindle assembly bracket 602 (as shown). In one embodiment, the front arms (112,114) may use a dual rack steering assembly located parallel (i.e., steering slots are parallel to longitudinal length of car) to the center line of the vehicle length. The steering mechanism moves in a longitudinal direction to turn the wheels left and right. The front arms can use a steel tube so the dual rack steering assembly can push and pull the spindle assembly steering bracket to turn the wheels in and out. As shown in FIG. 6A, the upper front arm 112 may comprise a plate and the plate may have a cutout that may align with the longitudinal center line of an ATV (cutout may accommodate a shock). A reference point 308 can have substantially the same distance when front arm(s) are moved vertically.

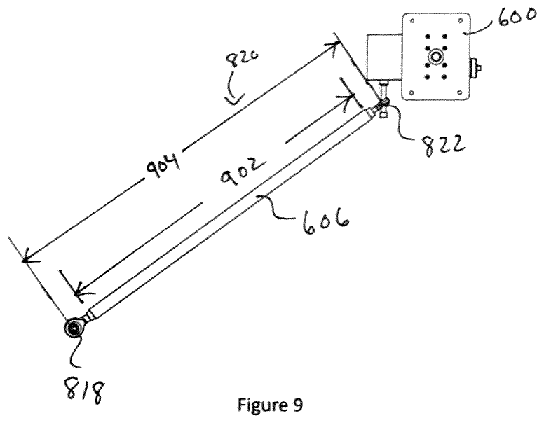

FIG. 7 shows by way of example an embodiment of an ATV with a front arm assembly 102 (with a first and second front arm 112, 114) with a shock 204 in a compressed dimension 700 configuration of approximately 25.5 inches. In one embodiment, the front arm assembly is rotated up from level a dimension 702 of approximately 16 degrees. As shown, in one embodiment, the first and second front arms (112, 114) are attached at a second and fourth attachment zones (116, 118) to the frame on a side pillar (for example at the passenger compartment). In one embodiment the tire fits on a wheel and the tire has a diameter 704 of 15 inches, 20 inches, 25 inches, 30 inches, 31 inches, 32 inches, 33 inches, 34 inches or more.

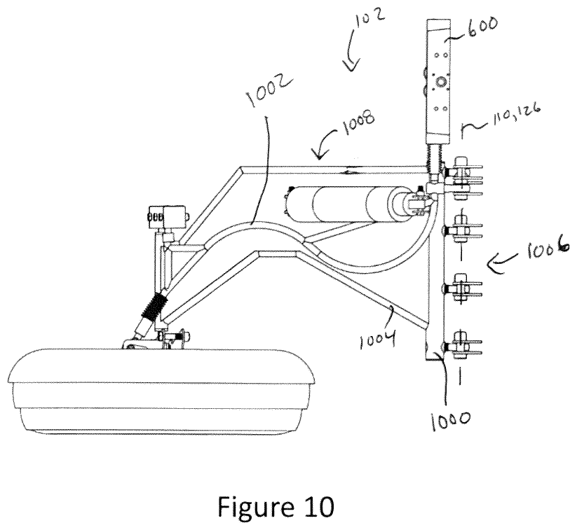

FIG. 8 shows by way of example a front arm assembly 102 and a dual rack steering assembly 820 as would be configured on an ATV, in an embodiment. The front arm assembly 102 has a hinge mechanisms (800, 804) configured to attach to ATV frame at a first and third attachment zone (200, 202) respectively and hinge mechanisms 802, 806 configured to attach to ATV frame 108 at a second and fourth attachment zone (116, 118) and hinge about a hinge line 126,110 when attached to the vehicle frame, wherein the hinge line(s) 126, 110 is substantially perpendicular to a longitudinal center line of the vehicle 302 (e.g., ATV). A dual rack steering assembly 820 as shown with dual rack 600 is located substantially inline with hinge line 126, 110. In one embodiment, the dual rack steering assembly rod proximal end 822 is located forward of hinge line 126, 110 a dimension 1306 that is equal distant (or as close as desired) to an amount the steering bracket rod distal end 818 is forward of the wheel axis 1104, or spindle assembly swivel line 824, so the steering arm 606 can swing in an arc similar to the front arms (112, 114), to prevent or reduce bump steer or binding. In another embodiment the dual rack steering assembly box 600 is behind the most frontward portion of the passenger compartment, for example, the foot area. The dual rack steering assembly tube 606 connects the dual rack assembly box 600 to the spindle assembly bracket. In one embodiment the straight steering tube 606 is angled from the dual rack steering box 600 to the spindle assembly. In some embodiments the dual rack steering assembly tube 606 may have an arcuate shape. In one embodiment a front arm (e.g., a lower front arm 114 and/or an upper front arm 1142) has a perpendicular length 826 that is substantially same dimension (e.g., less than 0.5 inch difference) from a first proximal portion end and a second proximal portion end, from the hinge line 126 to the spindle assembly swivel line 824 (in one embodiment it may be approximately 32.2 inches). In one embodiment a front arm (e.g., a lower front arm 114 and/or an upper front arm 1142) has a perpendicular length 826 that is substantially same dimension from a first and a second front arm proximal portion end, from the hinge line (e.g., 126) to the wheel axis line 1104. As shown, in one embodiment, the front arm 112, 114 may define a U-shaped portion 828 between the pivot mechanism (800, 804, 802, 806) zones. In one embodiment, the U-Shaped portion may have a max dimension along hinge line 126 of approximately 25 inches and a max dimension perpendicular to hinge line of approximately 9 inches. The U-shaped portion can be other shapes (e.g., a v shaped, arcuate shape) that create a non enclosed open space 828 between the hinge attachment zones (e.g., first and second front arm first and second proximal end portions (e.g., 808, 812) respectively). In one embodiment, as shown in FIG. 8, an ATV has a shock 204 and a first pivot mechanism zone (800,804) configured to be attached to the ATV frame and hinge about a pivot line 126, 110. A first front arm 112, is configured to attach to the shock (e.g. to the front arm tubes or a plate (1500), having a first front arm first proximal end portion 808 and a first front arm first distal end portion 810 opposite the first front arm first proximal end portion 808. The first front arm first proximal end portion 808 is configured to be attached to a first frame attachment zone 200 (see FIGS. 2 and 3A). In one embodiment, the first front arm 112 comprises a first front arm second proximal portion 812 and wherein the first front arm second proximal portion 812 is configured to be attached to the frame 108 (e.g., at a second frame attachment zone 116). In one embodiment the ATV comprises a second front arm 114 having similar characteristics as described herein for first front arm 112, wherein the second front arm 114 comprises a second front arm first proximal end portion 808′ and the second front arm first proximal end portion 808′ is configured to be attached to an ATV passenger frame 108 (e.g. a third frame attachment zone 202 as shown in FIG. 3A). In one embodiment, the second front arm 114 further comprises a second front arm second proximal portion 812′ and wherein the second front arm second proximal portion 812′ is configured to be attached to the passenger compartment frame 108 (e.g., attached to the fourth frame attachment zone 118). In one embodiment, the second front arm 114 further comprises a second front arm distal portion 814 configured to be attached to a spindle assembly.

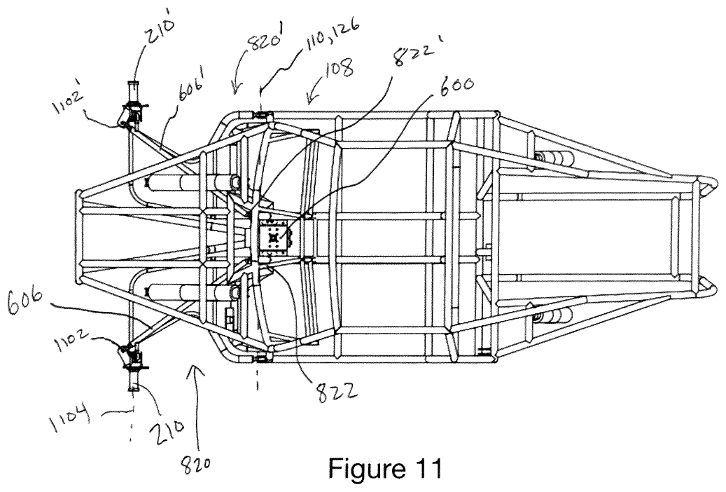

FIG. 9 shows by way of example a steering tube assembly 820 comprising a steering tube 606 and a steering box 600. In an embodiment, the steering tube 606 has a length dimension 902 of 36 inches with a proximal rod end 822 and a distal rod end 818 wherein the proximal rod end 822 is attached to a dual rack steering box 600 and distal rod end 818 connects to a rod end or mating mechanism at the spindle assembly bracket. The steering tube assembly length dimension 904 from rod end to rod end is approximately 40.5 inches and 1.25 inch diameter, in one embodiment.

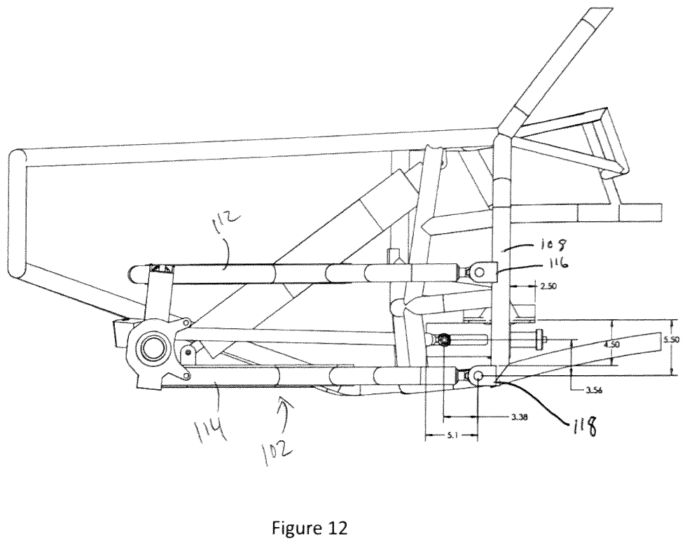

FIG. 10 shows by way of example an arcuate steering tube assembly 1008 configuration. The steering tube 1002 of the steering tube assembly 1008 has an arcuate shape. In one embodiment, the conventional single rack steering box 600 is located frontward of the foot box (for example frontward of the hinge lines 110,126 of front arm assembly 102 or substantially in line with the rearward portion (proximal portion) 1006 of the front arm assembly 102), an arcuate steering tube assembly may be used. A flexible steering material (e.g., a steel cable) may be inserted inside of the arcuate steering tube to facilitate wheel turn when steering is initiated.

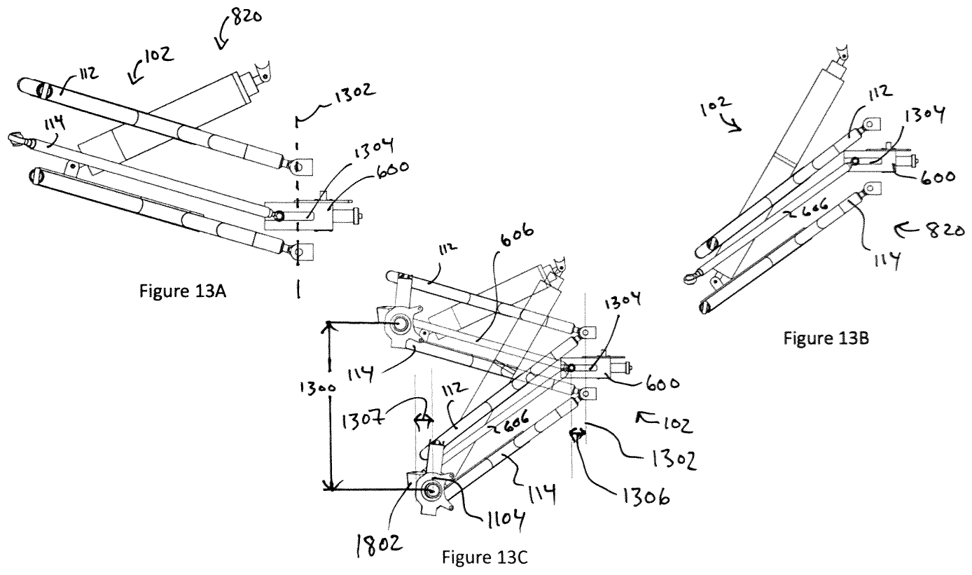

FIG. 11 shows by way of example, a dual rack steering assembly 820, 820′ mounted in an ATV frame 108 and substantially located behind the spindle assemblies 210, 210′. The dual rack steering assembly rod proximal end(s) 822, 822′ may be forward of hinge lines 110,126 an equal distance to the amount the dual rack steering steering rod distal end(s) 1102, 1102′ is forward of the wheel axis 1104 or steering bracket swivel line 824, so the steering arms (606, 606′) swing in an arc similar to the front arms, to prevent or reduce bump steer or binding. In another embodiment the dual rack 600 is behind the most frontward area of the passenger compartment, for example, the foot area, or in one embodiment substantially rearward of hinge lines 110, 126. The dual rack steering assembly 820, 820′ can have two dual rack steering tube assemblies (606, 606′). A first dual rack steering tube assembly for a driver side 820 and a second dual rack steering tube assembly for a passenger side 820′ (in one embodiment, the steering tube assembly on the driver side and passenger side share a steering tube box (dual rack) 600). The dual rack steering tube assemblies can be the same dimensions, so the spindle assemblies are substantially parallel to each other (e.g., keeping the front wheels substantially parallel) as the spindle assemblies are turned (i.e., when front wheels are turned).

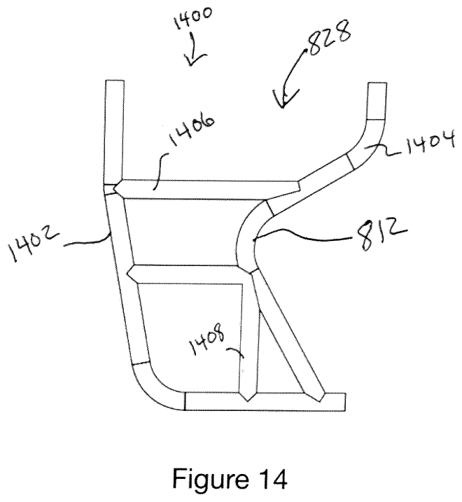

FIG. 12 shows by way of example, a front arm assembly 102, with the upper 112 and lower 114 front arms in a parallel position at mid vertical travel, and attached to a frame 108 at an outward attachment zone (116, 118).

FIGS. 13A, 13B, and 13C show by way of example, a front arm assembly 102 with the first front arm 112 and second front arm 114 positioned to show a range of motion. A dual rack steering assembly 820 with a dual rack steering tube 606 assembly is shown to connect to spindle assembly. FIG. 13A shows front arm assembly 102 in an upward configuration (shock compressed) and FIG. 13B shows the front arm assembly 102 in a downward configuration (shock extended). In FIG. 13C the steering tube assembly 820 is shown in a range of motion (e.g. when a vertical distance 1300 of approximately 28 inches is achieved). In one embodiment, the dual arm steering rack 600 is located substantially inline with vertical hinge line 1302 (e.g., vertical hinge line 1302 passes through steering box 600). The dual arm steering rack 600 is rotated 90 degrees from a conventional single rack steering assembly (to allow the steering rod slots 1304 to be in a longitudinal direction along the ATV). The dual arm steering rack slot 1304 is configured to allow the rearward portion of the steering tube 606 (e.g., steering rod proximal end 822) to be located forward a dimension 1306 (e.g., 3 inches) of vertical hinge line 1302 and the frontward portion of the steering tube 606 (e.g., steering rod distal end 818) to be located forward a dimension 1307 substantially matching dimension 1306 (e.g., 3 inches) of the wheel axis 1104, or spindle bracket swivel line 824. In one embodiment, the spindle assembly 214 has a steering tube bracket 1802 mounted at 45 degrees to accommodate this steering tube configuration.

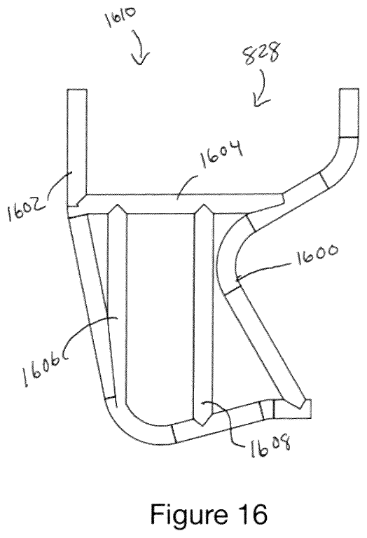

FIG. 14 shows by way of example, a lower front arm tube assembly 1400 per an embodiment. The lower front arm can be made with tubes of steel, e.g., a 1.75 inch diameter and 0.095 inch thick. The lower front arm tubes can have an arcuate shape 812 to accommodate a wheel turned up to 45 degrees. The lower front arm 112 can comprise tubes that define a U shaped configuration 828 that is configured to wrap around a frame portion, e.g., the foot area of the frame 108, in one embodiment. In one embodiment, an inner tube 1402 can have a dimension of 48.75 inches. An outer tube 1404 can have a length dimension of 38.125 inches. A connecting tube 1406 can have a dimension of 18 inches. A longitudinal connecting tube 1408 can have a length dimension of 12.25 inches.

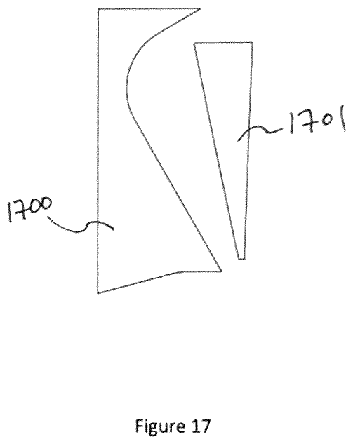

FIG. 15 shows by way of example a lower front arm plate 1500 that can be attached (and matching a substantial portion of the front arm profile) to the lower front arm tube assembly 1400.

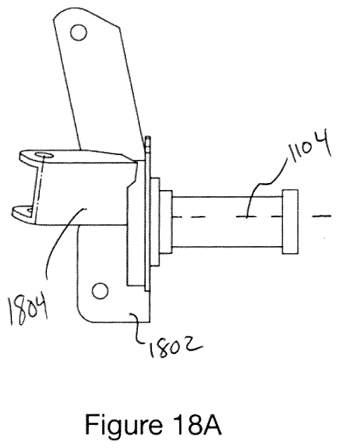

FIG. 16 shows by way of example a first upper front arm tube assembly 1610 (front arm 112 without end mechanisms shown) per an embodiment. The first front upper front arm tube assembly 1610 can be made of a 1.75 inch diameter tube and 0.095 inch thick. The first front upper front arm tube assembly 1610 can have an outer tube 1600 with an arcuate shape and a length dimension of 36.75 inches. The first front upper front arm tube assembly 1610 can have an inner tube 1602 with a length of 48.625 inches. The first front upper front arm tube assembly 1610 can have a connecting rearward tube 1604 with a length dimension of 16.625 inches. A wrap around portion 828 (a U-shaped portion so hinge mechanisms, for example 800, 802 that attach to proximal portions of the tube assembly can be located further rearward on the vehicle than the most forward point of U-shaped portion, e.g., 1604 connecting rearward tube). In one embodiment, the U-Shaped portion may have a max dimension along hinge line 126 (e.g., max dimension between inner tube 1602 and outer tube 1600) of approximately 25 inches (in other embodiments may be 20 inches, 30 inches) and a max dimension perpendicular to hinge line (e.g., max dimension from 1602 proximal end to tube 1604) of approximately 9 inches (in other embodiments may be 4 inches, 5 inches, 10 inches, or what is desired to achieve) . The front arm may have two longitudinal and substantially parallel connecting members 1606 and 1608 to accommodate a shock to pass through the front arm(e.g., when the front arm is assembled in a front arm configuration the connecting members will be substantially parallel to the ATV longitudinal length centerline). Connecting member 1606 can have a dimension of 17 inches and connecting member 1608 can have a dimension of 20 inches.

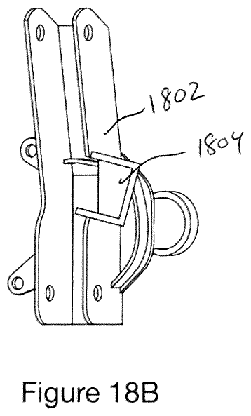

FIG. 17 shows by way of example an upper front arm plate(s) 1700, 1701 that can be attached to the upper front arm tube assembly. The plate can be 0.125 inch thick steel. In one embodiment the upper front arm plate 1700 and 1701 are configured to attach to the upper front arm leaving a slot for shock to pass through (e.g., aligned with tubes 1606 and 1608).

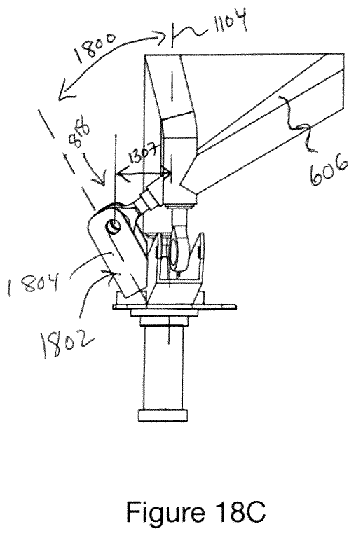

FIGS. 18A, 18B, 18C show a spindle assembly bracket 1802 per an embodiment. The steering bracket 1802 may have a steering bracket connection portion 1804 rotated a dimension 1800 of 45 degrees from wheel axis 1104, as shown in FIG. 18C. In other embodiments the steering bracket connecting portion 1804 can be rotated 35 degrees, or 60 degrees, or up to 90 degrees or a dimension necessary to align steering rod 606 an appropriate clearance from bracket 1802 to enable turning function when the dual arm steering rack 600 is located rearward of spindle assembly, or substantially inline with front arm assembly attachment zones, for example when the hinge line (e.g., 1302) passes through the steering rack 600). FIG. 18C shows steering rod distal end 818 being located forward a dimension 1307 of wheel axis 1104, that substantially aligns with dimension 1304 (as shown in FIG. 13C). 18B shows a view of bracket 1802.

What is claimed is:

1. A vehicle comprising:
a frame;
a first front arm, having a first front arm first proximal end portion and a first front arm first distal end portion;
wherein the first front arm first proximal end portion is configured to be attached in a hinged configuration to the frame at a first frame attachment zone; and
wherein when the first front arm is moved vertically between a first neutral configuration towards a second configuration wherein the second configuration is at least 7 inches from the first neutral configuration, a reference point along the first front arm has substantially the same lateral perpendicular dimension from a longitudinal centerline along the vehicle at the first neutral configuration and at the second configuration.

2. The vehicle of claim 1 wherein the first front arm further comprises a first front arm second proximal end portion and the second proximal end portion is attached to the frame in a hinged configuration at a second frame attachment zone.

3. The vehicle of claim 2 further comprising a second front arm wherein the second front arm comprises a second front arm first proximal end portion and the second front arm first proximal end portion is attached to the frame in a hinged configuration at a third frame attachment zone.

4. The vehicle of claim 3 further comprising a second front arm second proximal portion and wherein the second front arm second proximal portion is attached to the frame in a hinged configuration at a fourth frame attachment zone.

5. The vehicle of claim 2 wherein the hinged configurations of the first front arm comprises a hinge line along the first and second frame attachment zones wherein the hinge line is substantially perpendicular to a longitudinal centerline of the frame.

6. The vehicle of claim 4 wherein the hinged configuration of the second front arm comprises a hinge line along the third and fourth frame attachment zones wherein the hinge line is substantially perpendicular to a longitudinal centerline of the frame.

7. The vehicle of claim 4 wherein the first front arm and the second front arm are attached to the frame along respective hinge lines and the respective hinge lines are substantially perpendicular to a longitudinal centerline of the frame.

8. The vehicle of claim 7 wherein the first front arm and the second front arm comprise distal end portions attached to a spindle assembly.

9. The vehicle of claim 8 further comprising a shock attached to one of the first and second front arm and wherein the shock has a travel length and the first front arm and the second front arm are in a parallel configuration at some point throughout the shock travel length.

10. The vehicle of claim 8 wherein the first front arm and the second front arm are configured to allow a wheel assembly with a tire at least 20 inches to turn inward 45 degrees without contacting the first and second front arm.

11. The vehicle of claim 8 wherein the first and second front arms are configured to have a non enclosed space along hinge line between respective first and second front arm attachment zones.

12. The vehicle of claim 11 wherein the non enclosed space of at least one of the first and second front arms is a U-shaped configuration.

13. The vehicle of claim 11 wherein the non enclosed space accommodates a portion of the frame.

14. The vehicle of claim 4 wherein the reference point lateral perpendicular dimension varies less than 1 inch.

15. The vehicle of claim 4 wherein the reference point lateral perpendicular dimension varies less than 2 inches.

16. A front arm comprising:
a first front arm first proximal portion and wherein the first front arm first proximal portion is configured to be attached in a hinged configuration with a frame at a first frame attachment zone;
wherein the first front arm further comprises a first front arm distal portion configured to be attached to a spindle assembly; and
wherein when the first front arm is attached to the frame at the first frame attachment zone and when the first front arm distal portion is moved vertically upward at least 7 inches between a first configuration and a second configuration wherein the first configuration is at a neutral or intended ride height configuration, a reference point along the first front arm has a substantially equal perpendicular lateral distance from a longitudinal center line along the frame at the first and second configuration.

17. The front arm of claim 16 wherein the first front arm further comprises a second frame attachment zone configured to be attached to the frame in a hinged configuration.

18. The front arm of claim 17 wherein the first front arm comprises a non enclosed open space along a hinge line between the first and second frame attachment zones.

19. The front arm of claim 18 wherein the non enclosed space is configured to accommodate a portion of the frame.

20. A front arm for a vehicle suspension, comprising:
a first proximal portion configured to be hingedly attached to a vehicle frame at a first hinge point;
a second proximal portion configured to be hingedly attached to the vehicle frame at a second hinge point, the first and second hinge points defining a hinge axis;
Wherein the hinge axis is substantially perpendicular to a longitudinal centerline of the vehicle frame;
a distal portion configured to be attached to a spindle assembly at a spindle attachment point; and
wherein the front arm is configured such that a first perpendicular distance, measured perpendicular to the hinge axis from the first hinge point to the spindle attachment point axis, is substantially equal to a second perpendicular distance, measured perpendicular to the hinge axis from the second hinge point to the spindle attachment point.
